(19) United States
(12) Patent Application Publication
(10) Pub. No.: US 2005/0171639 A1
(43) Pub. Date: Aug. 4, 2005

(54) Self-running cleaner with anti-overturning capability

(75) Inventors: Naoya Uehigashi, Daito-shi (JP); Ryo Saeki, Daito-shi (JP)

Correspondence Address: OSHA LIANG L.L.P., 1221 MCKINNEY STREET, SUITE 2800, HOUSTON, TX, 77010, US

(73) Assignee: Funai Electric, Co., Ltd., Osaka (JP)

(21) Appl. No.: 11/045,747

(22) Filed: Jan. 28, 2005

(30) Foreign Application Priority Data
Jan. 30, 2004 (JP) JP2004-024040

(51) Int. Cl. G06F 19/00

(52) U.S. Cl. 700/245; 701/23

(57) ABSTRACT

An acceleration sensor is disposed on the center line of a main body to sense and output to a determination processing unit the acceleration component in three axial directions orthogonal to each other. The determination processing unit has a predetermined threshold value set for the acceleration in the z axis direction to determine the overturning possibility of the main body by the tilt angle of the main body exceeding a certain critical angle when falling short of the threshold value. The determination processing unit controls the travel steering unit so as to effect an obviation operation (for example, moving back the main body a predetermined distance and rotating the main body) to decrease the tilt angle of the main body, i.e. to increase the acceleration in the z axis directions. Thus, the main body is prevented from turning over.

### BACKGROUND OF THE INVENTION

1. Field of the Invention

The present invention relates to self-running cleaners, and more particularly to a self-running cleaner with the capability of detecting the posture/attitude of the main body and preventing overturning.

2. Description of the Background Art

Recently, self-running cleaners have been developed, equipped with travel steering means and travel control means to conduct cleaning automatically in a cordless manner with a loaded secondary battery (for example, refer to Japanese Patent Laying-Open Nos. 7-79890 and 2000-353013).

FIG. 9 is a side view of a conventional self-running cleaner disclosed in Japanese Patent Laying-Open No. 7-79890.

Referring to FIG. 9, the self-running cleaner includes, as cleaning means, a floor nozzle 20 disposed at the bottom of the main body, a dust chamber 22, a filter 23, and an electric blower 24.

The self-running cleaner further includes a driving wheel 25 and a trailing wheel 26 identified as travel steering means, a range sensor 42 identified as obstacle sensing means for sensing an obstacle during its travel, and a jyro sensor (not shown) identified as position identify means for identifying the position.

The self-running cleaner has the distance to the peripheral wall of the cleaning site measured through range sensor 42, and then identifies the cleaning area by the jyro sensor while moving along in accordance with the measured distance to the wall to clean the entire area based on autonomous travel while avoiding obstacles in the region.

The cleaning site may include step-graded areas such as steps and doorsills in the self-running region. There are cases where a main body 10 of self-running cleaner turns over or rolls sideways during the cleaning job, whereby the job is aborted or main body 10 is damaged.

To prevent main body 10 from turning over, the conventional self-running cleaner is further equipped with step sensing means for sensing a stepped portion in advance. Accordingly, the self-running cleaner stops during its travel upon sensing a stepped portion to avoid the stepped portion through a procedure similar to that of the obstacle sensing means.

The step sensing means includes, as shown in FIG. 9, a movable unit 27 provided at the bottom of main body 10, sensors 30a and 30b with rollers 28a and 28b, respectively, attached thereunder, switch means 32a and 32b formed of a micro switch and the like, a support mechanism formed of a support lever 34, a lever shaft 35 and a lever wire 36, and a travel control device 40.

A movable plate 27 is disposed horizontally lengthwise of main body 10, and attached rotatably via support shaft 39 to a support skid 38 whose trailing end is attached to main body 10 to pivot in the vertical direction.

Sensor 30a having a roller attached at the lower end is supported by a bearing 29a to be slidable with respect to movable unit 27. A projection 31a is provided at the top of sensor 30a to actuate switching means 32a when sensor 30a is moved downwards.

Support lever 34, lever shaft 35 and lever wire 36 constitute the support mechanism to support movable unit 27 at an upper position.

When main body 10 of the above-described configuration is running on a flat plane, sensor 30a is supported on the floor via roller 28a in a manner moved upwards with respect to movable unit 27.

When main body 10 approaches a concave step-graded portion during its travel and roller 28a arrives at the stepped portion, movable unit 27 will loose its support via roller 28a on the floor, inhibited of its pivoting motion at an angle equal to or greater than a predetermined angle, and attains a fixed state. The drop of roller 28a thereat causes sensor 30a to slide downwards with respect to movable unit 27, whereby projection 31a actuates switching means 32a. Switching means 32a is connected to travel control means 40. Upon actuation of switching means 32a, a procedure similar to that carried out when the obstacle sensing means is operated, is effected. Main body 10 stops its travel and is operated so as to avoid the stepped portion.

When trailing wheel 26 rides over a convex stepped portion so that the front of main body 10 is lifted upwards, movable unit 27 pivots downwards, whereby sensor 30a abuts against the floor via roller 28a. Since sensor 30a is supported on the floor in an upward moved state with respect to movable unit 27, switching means 32a will not operate. Thus, an erroneous operation is obviated.

The conventional self-running cleaner can detect a concave stepped portion in the floor during its travel via switching means 32a that is co-operative with sensor 30a. With regards to a convex stepped portion, switching means 32a will not operate even if the front side of main body 10 is lifted.

Accordingly, main body 10 can continue its cleaning job without stopping if the convex stepped portion on the floor is trivial. However, when the convex stepped portion is significant, the front side of main body 10 will ride over the stepped portion to lose its balance, leading to the possibility of main body 10 turning over.

In a typical household environment, there is generally a doorsill between the room that is the subject of cleaning and an adjacent room. If the concave or convex stepped portion such as the doorsill is smaller than the pivoting range of movable unit 27, the stepped portion may not be sensed, depending upon the structure of the doorsill. There is the disadvantage that main body 10 will exit the room that is the subject of cleaning. To eliminate the possibility of main body 10 exiting from the room that is the subject of cleaning during the cleaning job, the conventional self-running cleaner is adapted to arrange a virtual wall or the like at the boundary with an adjacent room to sense the boundary via a sensor mounted in main body 10.

In addition to the above-described stepped sensing means formed of a plurality of components to sense the vertical change in attitude of the main body, the conventional self-running cleaner includes auxiliary elements such as obstacle sensing means for avoiding collision with an obstacle, a virtual wall and the like. The various types of sensing means corresponding to respective objects will increase the complexity as well as the cost of the apparatus.

### SUMMARY OF THE INVENTION

In view of the foregoing, an object of the present invention is to provide a self-running cleaner that can readily prevent the main body from turning over at low cost.

Another object of the present invention is to provide a self-running cleaner that can detect the attitude of the main body properly to execute a cleaning job stably and efficiently.

According to an aspect of the present invention, a self-running cleaner includes a cleaning unit cleaning the floor, a travel steering unit for self-propelling of a main body, an acceleration sensing unit sensing acceleration of the main body, and a determination processing unit controlling the cleaning unit and the travel steering unit in response to an acceleration signal from the acceleration sensing unit. The determination processing unit includes a storage unit storing an output waveform of a plurality of acceleration signals corresponding to respective plurality of attitudes of the main body, a counting unit, and a control unit determining the attitude of the main body by collating an output waveform of an acceleration signal with the output waveform of a plurality of acceleration signals stored to control the travel steering unit and cleaning unit. With regards to two impacts appearing continuously at the output waveform of an acceleration signal in the vertical direction of the main body, determination is made of the main body passing over a doorsill by detecting occurrence of a succeeding impact within a predetermined term from a preceding impact to cause the main body to recede by the travel steering unit.

According to another aspect of the present invention, a self-running cleaner includes a cleaning unit cleaning the floor, a travel steering unit for self-propelling of the main unit, an acceleration sensing unit sensing acceleration of the main body, and a determination processing unit controlling the cleaning unit and the travel steering unit in response to an acceleration signal from the acceleration sensing unit. The determination processing unit determines the attitude of the main body based on the output waveform of the acceleration signal.

Preferably, the determination processing unit includes a storage unit storing an output waveform of a plurality of acceleration signals corresponding to respective plurality of attitudes of the main body. The determination processing unit has an output waveform of the acceleration signal collated with the output waveform of the plurality of acceleration signals stored to determine the attitude of the main body.

According to another aspect, the determination processing unit further includes a counting unit. With regards to two impacts appearing continuously at the output waveform of an acceleration signal in the vertical direction of the main body, determination is made of the main body passing over a doorsill by detecting occurrence of a succeeding impact within a predetermined term from a preceding impact to cause the main body to recede by the travel steering unit.

According to another aspect of the present invention, the determination processing unit compares an acceleration signal in the vertical direction of the main body with a predetermined threshold value and outputs to the travel steering unit a control signal that increases the acceleration signal in the vertical direction of the main body when the acceleration signal in the vertical direction of the main body is smaller than the threshold value as a result of comparison, whereby the travel steering unit executes an operation in accordance with the control signal.

Preferably, the travel steering unit rotates the main body 180° in accordance with the control signal.

Preferably, the travel steering unit moves the main body back a predetermined distance and rotates the main body in accordance with the control signal.

Preferably, the travel steering unit rotates the main body in a direction at which the acceleration signal in the vertical direction of the main body increases in accordance with the control signal.

Further preferably, the predetermined threshold value is smaller than the absolute value of the acceleration signal in the vertical direction of the main body immediately preceding the tilt and turn over of the main body.

According to an aspect of the present invention, damage of the main body and abortion of a cleaning job can be obviated by preventing the main body from turning over. Stability of the main body and the job efficiency can be ensured.

According to another aspect of the present invention, a plurality of types of sensors to detect the attitude of the main body can be aggregated to one acceleration sensor, allowing the fabrication cost to be reduced.

According to another aspect of the present invention, the configuration of detecting a doorsill by means of an acceleration sensor allows the accuracy of the cleaning job to be improved. Furthermore, addition of auxiliary elements is dispensable. The structure of the apparatus can be simplified and reduced in cost.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are a side view and a plan view, respectively, of a self-running cleaner according to a first embodiment of the present invention.

FIGS. 2A and 2B are schematic diagrams to describe the mechanism of the embodiment of the present invention.

FIGS. 3, 4 and 5 are flow charts to describe first, second, and third obviation operations, respectively.

FIGS. 6A-6F are waveform diagrams of the accelerations a_{z} in the z axis direction output from an acceleration sensor.

FIG. 7 is a flow chart to describe an operation of detecting the attitude of the main body based on output waveforms of FIGS. 6A-6F.

FIG. 8 is a flow chart to describe a travel control operation of a self-running cleaner according to a third embodiment of the present invention.

FIG. 9 is a side view of a conventional self-running cleaner disclosed in Japanese Patent Laying-Open No. 7-79890.

### DESCRIPTION OF THE PREFERRED EMBODIMENTS

Embodiments of the present invention will be described in detail hereinafter with reference to the drawings. In the drawings, the same or corresponding components have the same reference characters allotted, and description thereof will not be repeated.

### First Embodiment

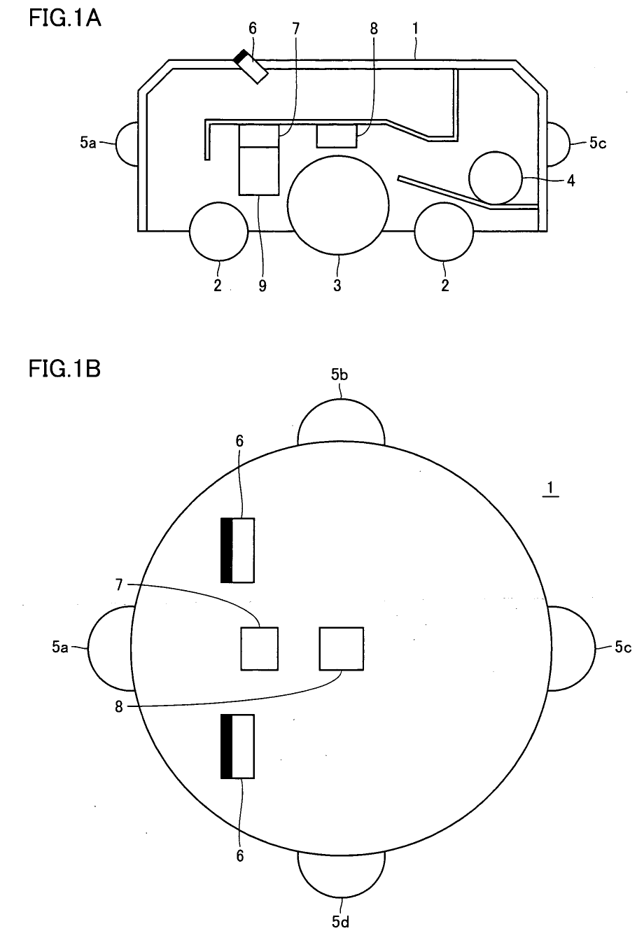

Referring to FIG. 1A, a self-running cleaner according to a first embodiment of the present invention includes a rolling brush 3 and a suction motor 4 as the cleaning unit, and a driving wheel 2 as the travel steering unit.

The self-running cleaner further includes a determination processing unit 9 for the entire control of the self-running cleaner. Determination processing unit 9 is formed of, for example, a microprocessor (MPU; microprocessor unit).

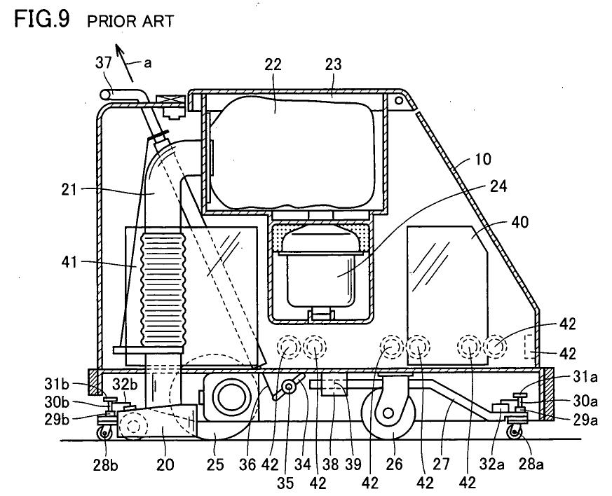

The cleaning unit and the travel steering unit are driven in response to designation from determination processing unit 9. The function of respective means is similar to those of the conventional self-running cleaner shown in FIG. 9. Therefore, description thereof will not be repeated here.

The self-running cleaner further includes, as shown in FIG. 1B, human body sensors 5a-5d and a proximity sensor 6 identified as an obstacle sensing unit, and a geomagnetic sensor 7 identified as a position identify unit.

Body sensors 5a-5d include a pair of sensors at the front side and back side of main body 1 (sensors 5a, 5c) and a pair of sensors at the left side and right side (sensors 5b, 5d) of main body 1. These four body sensors 5a-5b are formed of, for example, a pyroelectric sensor. A pyroelectric sensor takes advantage of the pyroelectric effect of charge appearing at the surface when a portion of the piezoelectric crystal is heated to detect energy in the proximity of 10 μm in wavelength emitted from the human body. In the configuration of FIG. 1, each of body sensors 5a-5d sense a human body entering a sensing range of ±45° about the arranged direction.

Geomagnetic sensor 7 is a sensor employed in the detection of the terrestrial magnetism, and the direction of the course of the self-running cleaner can be identified. In a normal operation, the self-running cleaner runs in a self-propelled manner with the detection signal from geomagnetic sensor 7 as the position information.

Proximity sensor 6 functions to detect the position when an obstacle is approaching, and is disposed inclined 45°, for example, upwards from the horizontal plane with respect to the advancing direction of the main body. Proximity sensor 6 senses an obstacle appearing in the course of main body 1 to measure the distance from the obstacle. Proximity sensor 6 is formed of, for example, a pair of passive sensors arranged perpendicular to the direction of advance of main body 1, as shown in FIG. 1B. Each of the passive sensors is formed of a plurality of passive sensor elements (not shown), having a sensing range proportional to the number of the sensor elements. In the present configuration, proximity sensor 6 senses the contrast of an obstacle with a pair of passive sensors to detect the distance from the obstacle based on the displacement of the position caused by the parallax of the obstacle projected on each passive sensor.

The self-running cleaner further includes an acceleration sensor 8 identified as the travel direction/travel speed recognition unit and tilt angle detection unit.

In addition to acceleration sensor 8 functioning as recognition means for the travel speed and travel direction, acceleration sensor 8 also functions to correct the three-dimensional attitude angle calculated from the measurements of an angular velocity sensor by the gravitational acceleration vector in the measurement of the three-dimensional attitude angle of an object to which acceleration sensor 8 is mounted, moving through the air, on the ground, under the ground, in the water, or the like, as disclosed in Japanese Patent Laying-Open No. 9-5104, for example. In the present embodiment, such an acceleration sensor is mounted in the self-running cleaner to allow detection of the degree of inclination of main body 1 with respect to the perpendicular direction to the floor. It is to be noted that a conventional self-running cleaner is not equipped with an acceleration sensor. This feature differentiates the self-running cleaner of the present embodiment from the conventional self-running cleaner.

In further detail, an acceleration sensor 8 is disposed on the center line of main body 1. Acceleration sensor 8 senses the acceleration (aₓ, a_{y} and a_{z}) in the direction of the 3 axes (x axis, y axis and z axis) orthogonal to each other. Acceleration sensor 8 outputs the change in the acceleration in each axial direction as an electric signal. The output signal from acceleration sensor 8 is transmitted to determination processing unit 9.

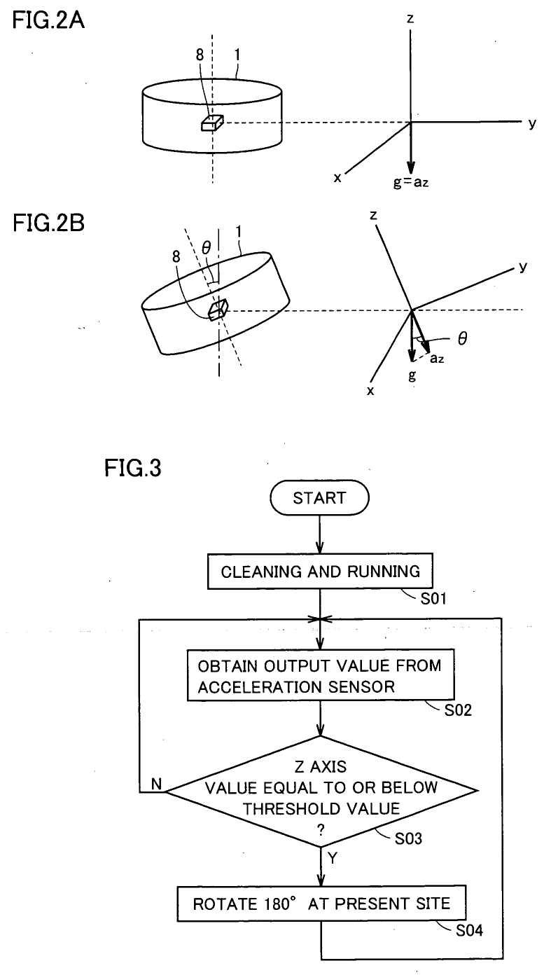

The principle of the present embodiment will be described with reference to FIGS. 2A and 2B.

Referring to FIG. 2A, acceleration sensor 8 disposed on the center line of main body 1 takes two directions horizontal to main body 1 and orthogonal to each other as the x axis and the y axis, and the direction perpendicular to main body 1 as the z axis. Acceleration sensor 8 senses the acceleration of each axis.

FIG. 2A corresponds to the case of a detected value of acceleration a_{z} in the z axis direction obtained in a normal cleaning job. When main body 1 is running on the floor, acceleration a_{z} in the z axis direction exhibits a constant value based on the sensing of the gravitational acceleration g (=9.8 m/s²).

FIG. 2B corresponds to the case where main body 1 is inclined. In this case, the acceleration component a_{z} of the z axis direction becomes smaller whereas the acceleration components aₓ and a_{y} in the direction of the x axis and y axis, respectively, increase. Specifically, the relationship of a_{z}=g·cos θ is established between acceleration a_{z} in the z axis direction and the gravitational acceleration g, where the tilt angle of main body 1 to the perpendicular direction of the floor is θ (0°≦θ≦90°). Therefore, the degree of inclination of main body 1 can be identified by sensing acceleration a_{z} in the z axis direction.

A predetermined threshold value is set with respect to acceleration a_{z} in the z axis direction. Determination is made that there is a possibility of main body 1 turning over corresponding to the tilt angle of main body 1 exceeding a certain critical angle when falling short of the threshold value. In this context, an obviation operation to reduce the tilt angle of main body 1, i.e. to increase acceleration a_{z} in the z axis direction, is to be conducted to prevent overturning.

As used herein, the critical angle refers to a tilt angle of the stage at which the center of gravity of main body 1 definitely changes by advancing farther. The threshold value of acceleration a_{z} in the z axis direction is set to a level of acceleration a_{z} when the tilt angle of main body 1 is slightly smaller than the critical angle. Accordingly, the overturning possibility of main body 1 can be identified in advance based on the threshold value.

The obviation operation when determination is made of the possibility of main body 1 overturning will be described hereinafter. The three ways set forth below for the obviation operation are cited as the means for increasing acceleration a_{z} in the z axis direction, i.e. restoring the tilt angle of main body 1 to 0°.

Referring to the flow chart of FIG. 3 corresponding to the first obviation operation, the self-running cleaner conducts a cleaning job while moving around on the floor (step S01). At this stage, acceleration sensor 8 in main body 1 senses and outputs respective acceleration components (aₓ, a_{y}, a_{z}) in the direction of the 3 axes (x, y, z) (step S02).

These output values are applied to determination processing unit 9. Determination processing unit 9 compares the acceleration a_{z} in the z axis direction with a preset threshold value (step S03).

When acceleration a_{z} in the z axis direction is smaller than the threshold value at step S03, determination is made that main body 1 attains a tilting attitude with the possibility of overturning by determination processing unit 9. In response, determination processing unit 9 causes main body 1 to rotate 180° at that site via the travel steering unit, such that acceleration a_{z} in the z axis direction increases (step S04). Accordingly, the tilt angle of main body 1 is reduced, whereby overturning can be obviated.

When acceleration a_{z} in the z axis direction is larger than the threshold value at step S03, determination processing unit 9 determines that main body 1 is capable of a normal operation to continue the cleaning job. Concurrently with the cleaning job, determination processing unit 9 returns the control to step S02 to monitor the output value of acceleration sensor 8 constantly to determine the possibility of overturning from the tilt angle of main body 1.

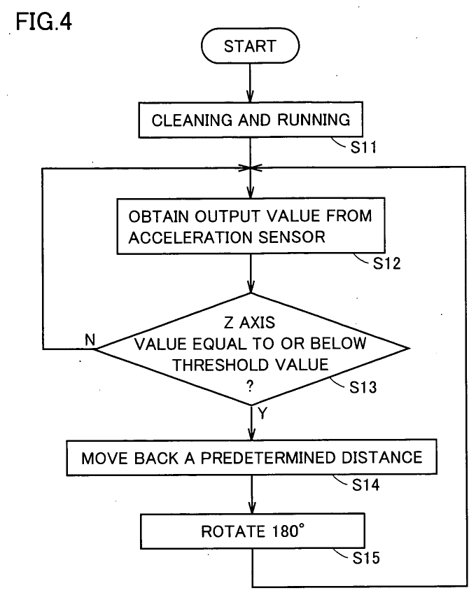

FIG. 4 is a flow chart corresponding to the second obviation operation.

Steps S11-S13 of the obviation operation of FIG. 4 are similar to steps S01-S03 of FIG. 3. The self-running cleaner moves around the floor to conduct a cleaning job while the tilt angle of main body 1 is sensed constantly through acceleration sensor 8. Furthermore, determination processing unit 9 compares acceleration a_{z} in the z axis direction with the threshold value to determine the overturning possibility of main body 1 based on the comparison result (step S13).

At this stage, when acceleration a_{z} in the z axis direction becomes equal to or below the threshold value, determination processing unit 9 causes main body 1 to move back a predetermined distance via the travel steering unit (step S14). By this operation, main body 1 is withdrawn from a stepped portion and the like that was the cause of inclination. The aforementioned predetermined distance of main body 1 moved backwards is set sufficiently such that main body 1 will not ride over the relevant stepped portion again when main body 1 resumes its travel after the obviation operation.

Then, determination processing unit 9 rotates main body 1 located at the receded site 180° through the travel steering unit (step S15). Control returns to step S12 to continue the cleaning job while sensing the tilt angle of main body 1.

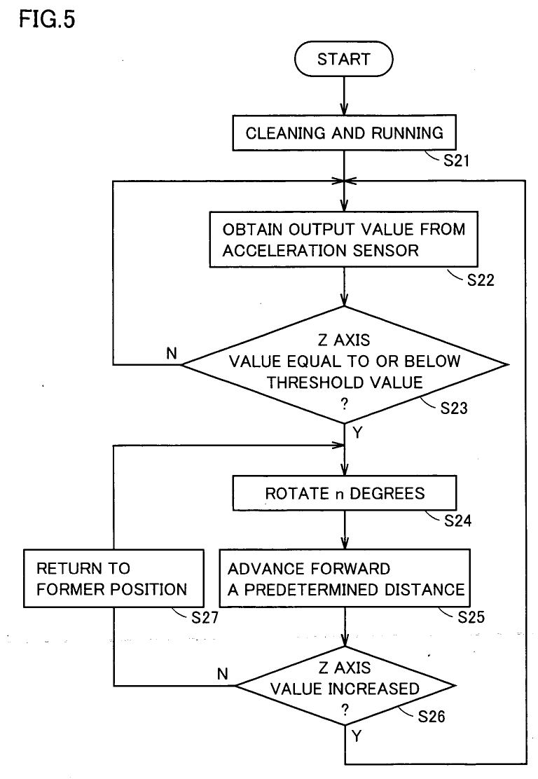

FIG. 5 is a flow chart corresponding to the third obviation operation. The acceleration detection operation in a normal running state (corresponding to steps S21-S23) in FIG. 5 is similar to that described with reference to FIGS. 3 and 4. Therefore, details of the description thereof will not be repeated. The obviation operation when acceleration a_{z} of the z axis direction becomes equal to or lower than the threshold value (step S23) will be described hereinafter.

When acceleration a_{z} in the z axis direction is equal to or below the threshold value at step S23, i.e. when determination is made of an overturning possibility of main body 1, determination processing unit 9 searches for a direction at which acceleration a_{z} in the z axis direction increases, and alters the direction of advance of main body 1 to this direction. Specifically, determination processing unit 9 rotates main body 1 for every n° (n=360°/m; m is the number of steps) through the travel steering unit (step S24). Main body 1 is moved forward just by a constant distance at every one rotation (step S25).

Following this forward advance, acceleration a_{z} in the z axis direction is sensed, and determination is made whether this value is larger than acceleration a_{z} in the z axis direction sensed at step S22 (step S26).

When determination is made that the sensed value of the new acceleration a_{z} in the z axis direction has increased at step S26, determination processing unit 9 determines that the tilt of main body 1 has been alleviated. Control returns to step S22 to resume the cleaning job while continuing the sensing operation through the acceleration sensor.

When determination is made that the new acceleration a_{z} in the z axis direction has not increased than the previous sensed value at step S26, main body 1 is moved backwards by a constant distance to return to its former position (step S27). Then, main body 1 is further rotated n° and moved forward by the constant distance (steps S24, S25). Determination is made whether acceleration a_{z} in the z axis direction has increased or not (step S26). The series of operation represented by steps S24-S26 is repeated while altering the rotation angle until increase of acceleration a_{z} in the z axis direction has been identified. Eventually, when detection is made of an increased acceleration a_{z} in the z axis direction, control returns to step S22 to resume the cleaning job and acceleration sensing operation.

All the first to third obviation operations set forth above are characterized in that the overturning possibility of main body 1 is sensed in advance to obviate such an event, and the cleaning job is continued following the obviation operation. By virtue of such a feature, the self-running cleaner of the present invention has higher job efficiency than the conventional self-running cleaner that stops or takes a detour upon sensing an obstacle or a stepped portion.

By the above-described structure of determining the possibility of overturning based on a sensed tilt angle through an acceleration sensor in accordance with the first embodiment, the main body can be prevented from turning over.

Furthermore, a plurality of sensors constituting a step sensing means in a conventional self-running cleaner can be aggravated to a unitary acceleration sensor, allowing reduction of the size and fabrication cost of the cleaner.

### Second Embodiment

The previous embodiment is directed to means for detecting the overturning possibility of the main body based on a change in acceleration a_{z} in the z axis direction via an acceleration sensor. The inventors found that acceleration a_{z} in the z axis direction will vary, not only in accordance with the tilt of the main body as described above, but also in accordance with the change of the main body attitude. The second embodiment is directed to a configuration of detecting the attitude of the main body based on an output from the acceleration sensor.

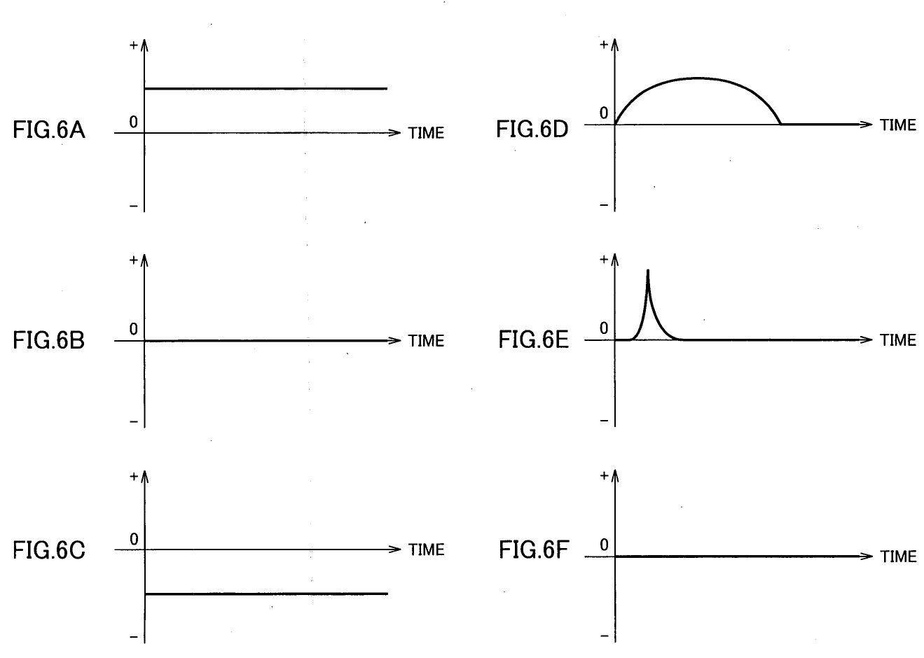

The waveform diagrams of FIGS. 6A-6F of acceleration a_{z} in the z axis direction output from acceleration sensor 8 shown in FIGS. 1A and 1B correspond to variation in the operational status due to an external action on main body 1. Respective actions will be described hereinafter.

FIG. 6A represents an output waveform of acceleration a_{z} in the z axis direction detected in a normal operation. It is appreciated from FIG. 6A that acceleration a_{z} in the z axis direction maintains a constant value equal to gravitational acceleration g in a normal running operation.

FIG. 6B represents an output waveform of acceleration a_{z} in the z axis direction when main body 1 rolls over sideways. As set forth above in the previous embodiment, the z axis direction component of gravitational acceleration g becomes smaller in accordance with the inclination of main body 1 to eventually indicate the 0 level by rolling over sideways.

FIG. 6C represents an output waveform of acceleration a_{z} in the z axis direction when main body 1 turns upside down. When main body 1 turns upside down by some external effect, acceleration a_{z} in the z axis direction is equal to an inverted version of the waveform of FIG. 6A.

FIG. 6D represents an output waveform of acceleration a_{z} in the z axis direction when main body 1 is lifted up. When main body 1 is lifted up, acceleration in the z axis direction is exhibited during the lifted up term t. Therefore, a waveform of acceleration a_{z} in the z axis direction that varies during term t is achieved.

FIG. 6E represents an output waveform of acceleration a_{z} in the z axis direction when main body 1 collides with an obstacle. When the impact by the collision is applied on main body 1, acceleration a_{z} in the z axis direction exhibits an abrupt change in a short period. It is to be noted than an abrupt change, likewise that of FIG. 6E, is observed in the output waveforms of acceleration components aₓ and a_{y} in the x axis direction and y axis direction, respectively.

FIG. 6F represents an output waveform of acceleration a_{z} in the z axis direction when main body 1 falls. During the falling motion, the acceleration sensor mounted on main body 1 outputs a signal of the 0 level for the output waveform of acceleration a_{z} in the z axis direction since the law of inertia is established, i.e. attains the so-called microgravity.

Since the output waveform of acceleration sensor 8 exhibits a change in accordance with the attitude of main body 1, the status of main body 1 can be identified even by a user distant from main body 1 by monitoring the output waveform through determination processing unit 9 to notify an abnormal event of main body 1 by audio or the like. Accordingly, a rapid response can be taken.

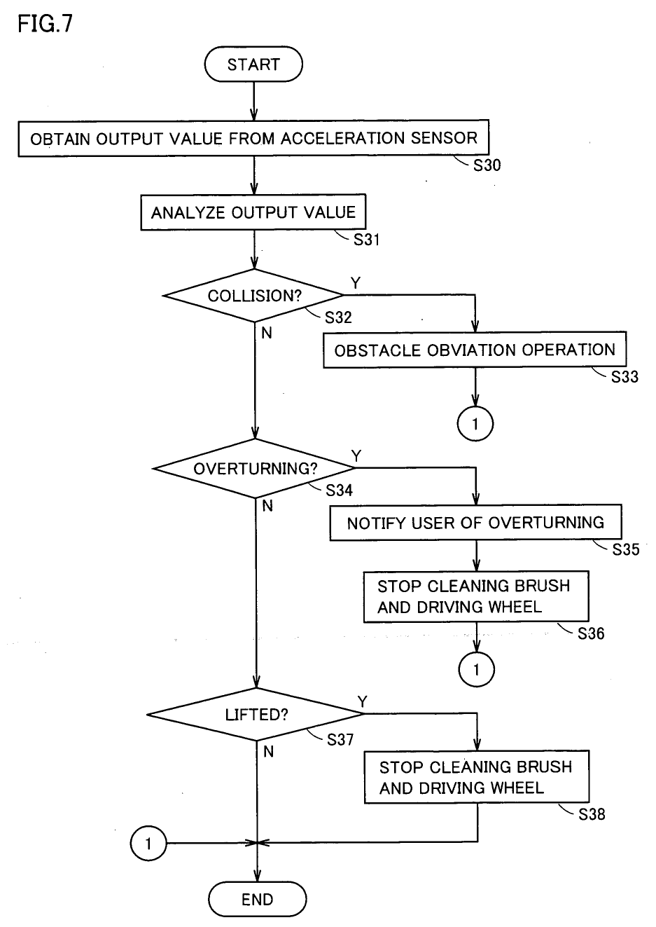

FIG. 7 is a flow chart to describe the operation of detecting the attitude of main body 1 based on the output waveforms of FIGS. 6A-6F from acceleration sensor 8.

Referring to FIG. 7, determination processing unit 9 acquires the output waveform from acceleration sensor 8 concurrent with the cleaning job (step S30). Acceleration sensor 8 outputs the acceleration component (aₓ, a_{y}, a_{z}) in each of the three independent axial directions.

Determination processing unit 9 detects the attitude of main body 1 from the output waveform of the obtained acceleration (step S31). The output waveforms of FIGS. 6A-6F are prestored in a storage circuit in determination processing unit 9. Determination processing unit 9 collates the obtained output waveform from acceleration sensor 8 with the output waveforms of FIGS. 6A-6F to determine as to which of attitudes main body 1 takes.

When an abrupt change as shown in FIG. 6E is identified in the output waveform (step S32), determination processing unit 9 determines that main body 1 has collided against an obstacle, and instructs the travel steering unit to conduct an operation of obviating the obstacle (step S33).

Alternatively, when an inversion as shown in FIG. 6C is identified in the output waveform (step S34), determination processing unit 9 determines that main body 1 has turned upside down, and notifies the user of the overturn through indication means such as of audio or display (step S35). Further, determination is made that the job cannot be continued, and ceases the travel steering unit and cleaning unit (step S36).

When a change over a constant term as shown in FIG. 6D is identified in the output waveform at step S31, determination processing unit 9 determines that main body 1 has been lifted up, and ceases the travel steering unit and cleaning unit to stop the cleaning job (step S38).

In a similar manner, determination processing unit 9 notifies the user a relevant event through the indication means for attitudes other than collision, inversion, and lift-up set forth above. Accordingly, the user can identify the attitude of the self-running cleaner even from a remote site to rapidly respond to the change in the attitude.

According to the second embodiment of the present invention, the job efficiency can be improved since the attitude of the main body can be detected readily to allow an appropriate response.

Furthermore, since a plurality of sensing means that was previously distributed corresponding to a plurality of potential attitudes in the self-running cleaner can be aggregated into a unitary acceleration sensor, reduction of the size and cost of the apparatus can be achieved.

### Third Embodiment

By the self-running cleaner of the present invention set forth above, the attitude of the main body can be detected based on the variation in the output waveform from the acceleration sensor, and overturning of the main body can be obviated from the detected result. The third embodiment is directed to a configuration of controlling the running function of the main body by monitoring the output waveform from the acceleration sensor to improve the job accuracy.

A self-running cleaner generally conducts a cleaning job through the cleaning means while running around in a room that is the subject of cleaning by the travel steering unit. At the boundary between the room that is the subject of cleaning and an adjacent room, there is generally a doorsill corresponding to a groove to open and close a door, a curtain panel, or the like. Since the conventional self-running cleaner cannot identify the doorsill from an obstacle by a step sensing unit, the conventional self-running robot may ride over the doorsill to exit the room that is the subject of cleaning if the door is open during the cleaning job, leading to degradation of the accuracy and efficiency of the cleaning job.

The self-running cleaner of the third embodiment is directed to a configuration of sensing properly a doorsill to control the running operation of the main body using the output waveform from the acceleration sensor. The self-running cleaner of the present embodiment is advantageous in that exit of the main body from the room that is the subject of cleaning can be prevented during the cleaning job.

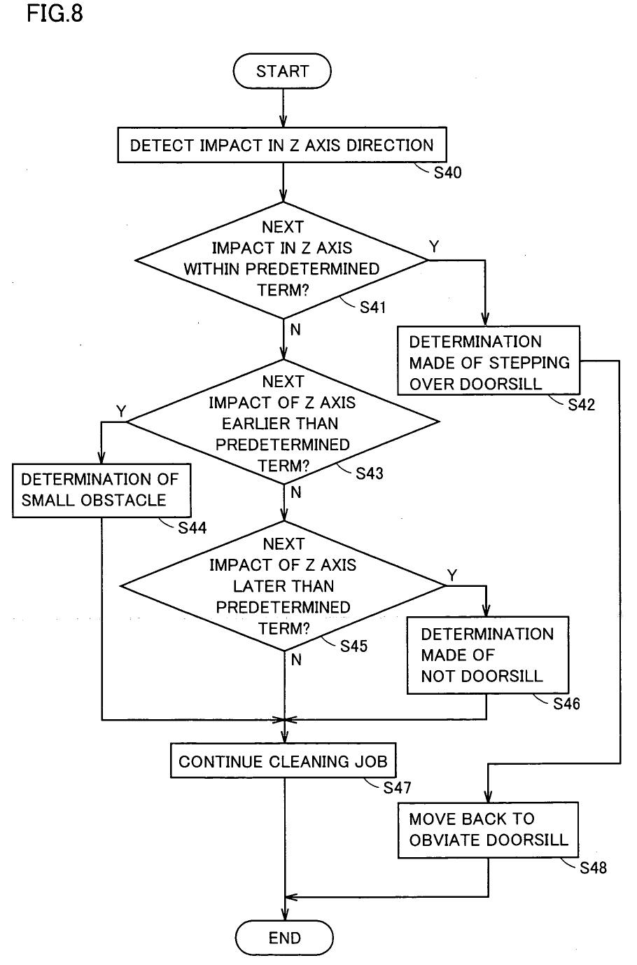

FIG. 8 is a flow chart to describe the running control operation of the self-running cleaner of the third embodiment. The self-running cleaner of the present embodiment has a configuration similar to that previously described with reference to FIGS. 1A and 1B. Acceleration sensor 8 constantly senses the acceleration in the three axial directions during a running operation of main body 1, and provides the sensed result to determination processing unit 9. Determination processing unit 9 determines the attitude of main body 1 from a change in the output waveform from acceleration sensor 8 to send an appropriate instruction to the travel steering unit and cleaning unit in accordance with the determination result.

At the beginning, it is assumed that an abrupt change in the output waveform of acceleration a_{z} in the z axis direction has been identified by determination processing unit 9 (step S40). Determination processing unit 9 takes this impact from the floor as the first impact, and begins to count the elapse of time through an internal counting unit starting from the first impact.

Then, determination processing unit 9 determines whether another impact from the floor has occurred when the elapsed time (time point) from the first impact is within the range of a predetermined term (step S41). As used herein, the “predetermined term” is a period of time having a prescribed time width, corresponding to the elapsed time from the first impact. This predetermined term is preset by the user based on the shape of the doorsill (width and the like) of the room that is the subject of cleaning and the running speed of main body 1. This preset term is stored in the storage means in determination processing unit 9.

When detection is made of an impact in the output waveform from acceleration sensor 8, and this second impact has occurred within the predetermined term at step S41, determination processing unit 9 determines that main body 1 has stepped over the doorsill (step S42).

In this event, determination processing unit 9 determines that there is a possibility of main body 1 exiting from the room that is the subject of cleaning. Main body 1 is moved back by the travel steering unit to avoid the doorsill (step S48).

Alternatively, when the second detected impact from the floor has not occurred within the predetermined term at step S41, control proceeds to step 43 where determination processing unit 9 determines whether the second impact has occurred earlier than the predetermined term.

When the second impact has occurred earlier than the predetermined term, determination processing unit 9 determines that main body 1 has stepped over a relatively small obstacle (step S44). Thus, the cleaning job is continued (step S47).

Alternatively, when the second impact has occurred later than the predetermined term, determination processing unit 9 determines that the obstacle over-passed by main body 1 is not the doorsill (step S46). Thus, the cleaning job is continued (step S47).

When the second impact is not detected within or outside the predetermined term through steps S41, S43, and S45, determination processing unit 9 resets the counting unit, and the cleaning job is continued (step S47).

In accordance with the third embodiment of the present invention, determination is made of the presence of a doorsill when the impact from the floor is detected two times at a predetermined interval, and operation is conducted so as to return to the former position without riding over the doorsill. Accordingly, the main body will not exit from the room that is the subject of cleaning during the cleaning job. Thus, high job accuracy and job efficiency can be realized.

Furthermore, auxiliary elements such as a virtual wall that was provided in a conventional self-running cleaner is not required. Therefore, a simple and economic configuration of the apparatus can be achieved.

Although the present invention has been described and illustrated in detail, it is clearly understood that the same is by way of illustration and example only and is not to be taken by way of limitation, the spirit and scope of the present invention being limited only by the terms of the appended claims.

1. A self-running cleaner comprising:
a cleaning unit cleaning a floor,
a travel steering unit for self-propelling of a main body,
an acceleration sensing unit sensing acceleration of said main body, and
a determination processing unit controlling said cleaning unit and said travel steering unit in response to an acceleration signal from said acceleration sensing unit,
wherein said determination processing unit comprises
a storage unit storing an output waveform of a plurality of said acceleration signals corresponding to respective plurality of attitudes of said main body,
a counting unit, and
a control unit determining the attitude of said main body by collating an output waveform of said acceleration signal with an output waveform of said plurality of acceleration signals stored to control said travel steering unit and said cleaning unit,
wherein determination is made of said main body passing over a doorsill by detecting occurrence of a succeeding impact within a predetermined term from a preceding impact to cause said main body to recede by said travel steering unit when two impacts appear continuously at the output waveform of an acceleration signal in a vertical direction of said main body.

2. A self-running cleaner comprising:
a cleaning unit cleaning a floor,
a travel steering unit for self-propelling of a main body,
an acceleration sensing unit sensing acceleration of said main body, and
a determination processing unit controlling said cleaning unit and said travel steering unit in response to an acceleration signal from said acceleration sensing unit,
wherein said determination processing unit determines an attitude of said main body based on an output waveform of said acceleration signal.

3. The self-running cleaner according to claim 2, wherein said determination processing unit comprises a storage unit storing an output waveform of a plurality of said acceleration signals corresponding to respective plurality of attitudes of said main body, and collates an output waveform of said acceleration signal with an output waveform of said plurality of acceleration signals stored to determine the attitude of said main body.

4. The self-running cleaner according to claim 3, wherein said determination processing unit further comprises a counting unit, and determination is made of said main body passing over a doorsill by detecting occurrence of a succeeding impact within a predetermined term from a preceding impact to cause said main body to recede by said travel steering unit when two impacts appear continuously at the output waveform of an acceleration signal in a vertical direction of said main body.

5. The self-running cleaner according to claim 2, wherein
said determination processing unit compares an acceleration signal in a vertical direction of said main body with a predetermined threshold value to output a control signal that increases the acceleration signal in the vertical direction of said main body to said travel steering unit when said acceleration signal in the vertical direction of said main body is smaller than said threshold value as a result of the comparison, and
said travel steering unit executes an operation in accordance with said control signal.

6. The self-running cleaner according to claim 5, wherein said travel steering unit rotates said main body 180° in accordance with said control signal.

7. The self-running cleaner according to claim 5, wherein said travel steering unit moves said main body back a predetermined distance and rotates said main body in accordance with said control signal.

8. The self-running cleaner according to claim 5, wherein said travel steering unit rotates said main body in a direction at which said acceleration signal in the vertical direction of said main body increases in accordance with said control signal.

9. The self-running cleaner according to claim 5, wherein said predetermined threshold value is smaller than an absolute value of said acceleration signal in the vertical direction of said main body immediately before said main body tilts and turns over.
